(19) United States
(12) Patent Application Publication
(10) Pub. No.: US 2004/0035112 A1
(43) Pub. Date: Feb. 26, 2004

(54) Air cooled auxiliary power unit for vehicles

(76) Inventor: Jitesh Bhabra, Woodbridge (CA)

Correspondence Address: Santosh K. Chari, McCarthy Tetrault LLP, 66 Wellington Street West, Suite 4700, P.O. Box 48, Toronto, ON, M5K 1E6, CA

(21) Appl. No.: 10/390,160

(22) Filed: Mar. 18, 2003

Related U.S. Application Data
(60) Provisional application No. 60/364,633, filed on Mar. 18, 2002.

(51) Int. Cl. F01B 21/04; F01K 23/00; F02B 73/00

(52) U.S. Cl. 60/698

(57) ABSTRACT

The present invention is directed to an auxiliary power unit for use with a vehicle, typically a truck. The power unit uses an air-cooled generator and associated auxiliary engine to supply power and air regulation requirements to the truck on demand. The air-cooled auxiliary engine is employed with an electrical generator and a compressor to provide the auxiliary power unit. The unit is self-contained in that it is not interconnected with the vehicle liquid coolant systems. A remote control module directs the operation of the power unit to supply heating and air conditioning to the vehicle interior by a sleeper unit. The sleeper unit provides a heating source and a coolant source that are powered by the power unit. A housing for the power unit is designed to assist in cooling and maintenance of the power unit. A series of air inlets are used to direct cooling air from the surrounding air over the generator, engine, and a condenser, so that operating temperatures of the power unit van be maintained within acceptable parameters. The housing also has an access cover that allows the contained power unit to be removed from the housing on a series of guides or channels, thereby facilitating the serviceability of the unit.

The present application claims priority from U.S. Provisional application No. 60/364,633, filed Mar. 18, 2002.

### FIELD OF THE INVENTION

The present invention relates to an apparatus and method for providing auxiliary air conditioning, heating, and power to a vehicle.

### DESCRIPTION OF THE PRIOR ART

There is a current need for providing auxiliary cooling, heating, and power to a vehicle, such a transport truck. The air temperature control is normally done by an onboard heating system including a heater in both the cab and sleeper cabin of the truck, and by an air conditioning system including an evaporator in both the cab and sleeper. These liquid cooled systems are driven by the truck engine during daytime operation of the truck. In the event of taking a rest or sleep break, the trucker must continue to run the truck engine in order to maintain operation of the air and heat systems in the sleeper cabin. One advantage of this direct heating and cooling system is that no modification to the existing truck infrastructure is needed to operate the air temperature control. However, this direct system is highly inefficient as the truck engine capacity, when idling, is being used solely for air temperature control. It has been found that it is more efficient to use small auxiliary generators to provide power for heating and cooling, rather than rely upon track engine operation when the truck is stationary.

Accordingly, cross-country truckers prefer to control the temperature of the ambient air in the sleeper cabin using auxiliary power units, which are connected to the main air treatment systems of the truck. In regions where cold weather is encountered, the engine is often idled when the vehicle is parked in order to keep the truck's motor oil, diesel fuel, and engine warm so that it will restart. Therefore, it is known to use liquid cooled auxiliary generator/engine systems to keep a turned off truck engine warm by interconnecting, through a complicated series of check valves, the auxiliary liquid coolant lines of the auxiliary engine with the standard coolant lines of the truck engine. The check valve system is used to prevent damage to the auxiliary and truck engine cooling systems in the event they are run simultaneously. One advantage of this system is that a more efficient use of auxiliary engine power is employed to control the air temperature of the cabin while the truck engine is turned off, as well as to keep the truck engine and related components warn with the heat by-products produced by the auxiliary engine. However, the disadvantage is that this system of interconnected liquid coolant lines to distribute the heat by-products may void the warranty of the truck, due to the extensive retrofit that is required to install the interconnections. Further, this system is more costly to maintain due to the greater complexity present in the valving architecture. Another problem with this system is that the operation of the auxiliary engine may be inhibited in the event of a breakdown in the truck coolant lines and associated components, due to the required cooperation between the truck and auxiliary coolant lines.

Another auxiliary liquid cooled power unit is described by U.S. Pat. No. 5,333,678 by Mellum et al. This patent involves auxiliary refrigerant lines that are separate and distinct from the vehicle's refrigerant lines, which allows the vehicle's compressor and the auxiliary compressor to ran simultaneously. Further, the auxiliary liquid coolant lines and the vehicle coolant lines are interconnected, which still allows for the unit to provide heat when the vehicle engine is running or not. However, this system still has some of the above mentioned inherent problems due to the retrofit that is required, as well as maintenance issues due to the complexity of the interconnections.

Therefore, all of the above described auxiliary power units are liquid cooled units that involve complex interconnections between the vehicle engine and the auxiliary engine. It is desirable to supply power and air temperature control to a vehicle, while minimising the use of extensive retrofits of the original truck infrastructure.

A further problem common to most current auxiliary power units is serviceability. Even if the units each have a completely removeable cover, the units are often mounted snugly between the truck fuel tank and the front side of the rear wheel under the sleeper cabin. This configuration can prevent several items on the power unit from being serviced, without removing the complete unit from the truck. This can be very time consuming and also costly if the air conditioning system (A.C.) has to be drained and then recharged on re-assembly.

Other problems typically encountered with current auxiliary power units is that they use belt driven A.C. compressors, or they are completely self-contained roof mounted A.C. units. The belt driven A.C. compressors require an electric clutch in the A.C. sheave to turn it on and off, which adds another maintenance item along with the belt. The roof mounted A.C. units are not compatible with current design truck sleeper cabins as the truck roof is not flat, which is required for a roof mount A.C.

It is an object of the present invention to provide an auxiliary power unit to obviate or at least mitigate some of the above-presented disadvantages.

### SUMMARY OF THE INVENTION

Current auxiliary power units are liquid cooled units that involve complex interconnections between die vehicle engine and the auxiliary engine. It is desirable to supply power and air temperature control to a vehicle, while minimising the use of extensive retrofits of the original truck infrastructure. According to the present invention, an air-cooled auxiliary engine is employed with an electrical generator and a compressor to provide an auxiliary power unit. The unit is self-contained in that it is not interconnected with the vehicle liquid coolant systems. A remote control module directs the operation of the power unit to supply heating and air conditioning to the vehicle interior by a sleeper unit. The sleeper unit provides a heating source and a coolant source that are powered by the power unit.

The present invention also provides a housing for the power unit that assists in cooling and maintenance. A series of air inlets are used to direct cooling air from the surrounding air over the generator, engine, and a condenser, so that operating temperatures of the power unit van be maintained within acceptable parameters. The housing also has an access cover that allows the contained power unit to be removed from the housing on a series of guides or channels, thereby facilitating the serviceability of the unit.

### BRIEF DESCRIPTION OF THE DRAWINGS

These and other features of the preferred embodiments of the invention will become more apparent in the following detailed description in which reference is made to the appended drawings wherein:

FIG. 1 is a side view of a vehicle with a mounted auxiliary power unit;

FIG. 2 is a block diagram of the power unit of FIG. 1;

FIG. 3 is a remote control module for the power unit of FIG. 2;

FIG. 4 is a diagram of the cooling system for the power unit of FIG. 2; and

FIG. 5 is a side view of a housing for the power unit of FIG. 1; and

FIG. 6 is a second embodiment of the control module of FIG. 3.

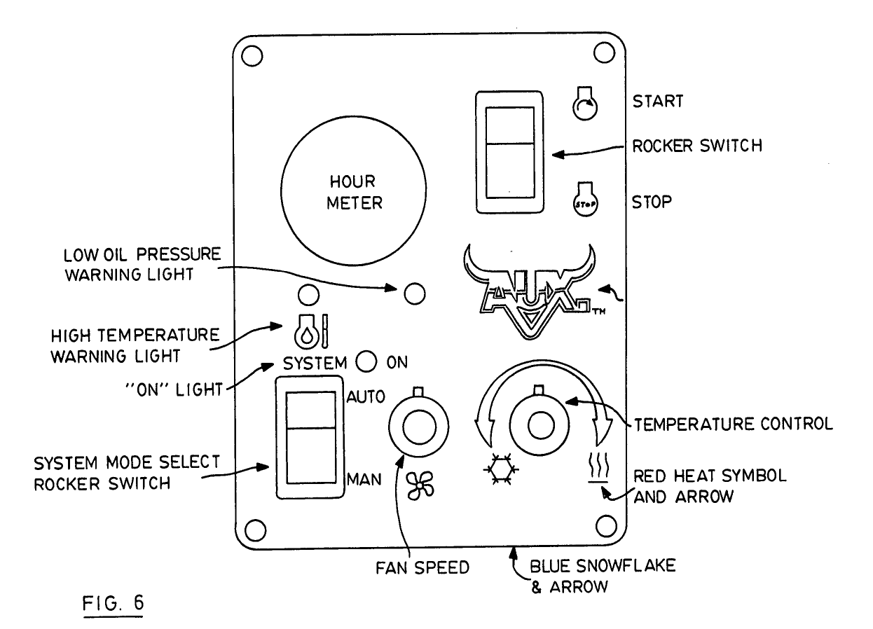

### DESCRIPTION OF THE PREFERRED EMBODIMENTS

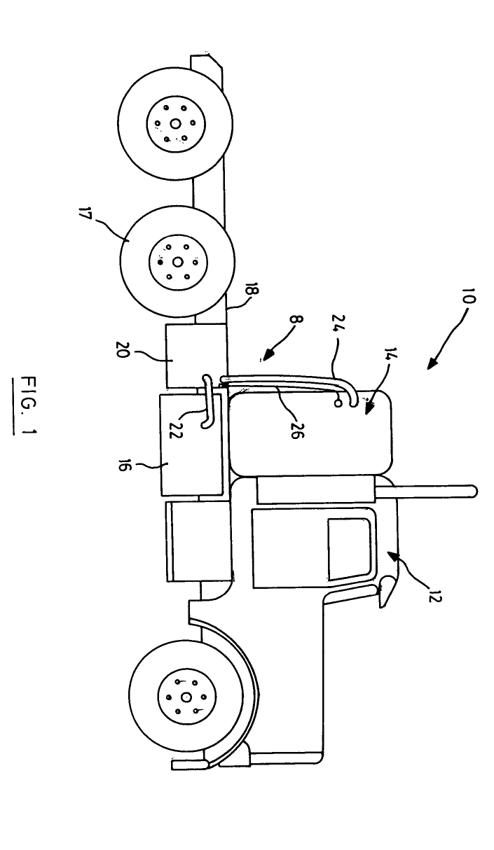

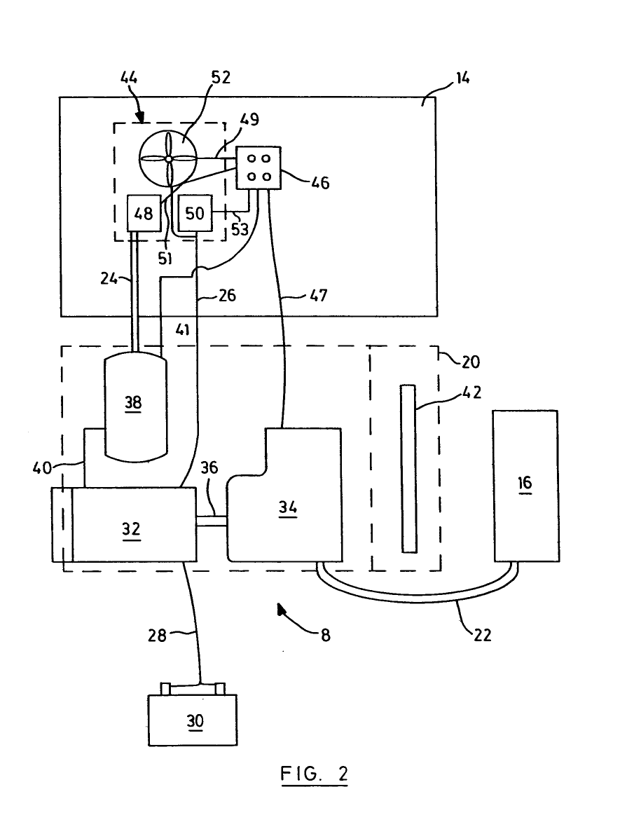

Referring to FIG. 1, an auxiliary power unit 8 for providing air temperature control and power to a vehicle 10 is contained within a housing 20, which is connected to a rail 18. Combustable fuel requirements for the power unit 8 are supplied through a fuel line 22, which is connected to a fuel tank 16 mounted on the vehicle 10. Liquid refrigerant lines 24 and an electrical power line 26 are connected from the power unit 8 to a sleeper unit 44 (see FIG. 2), mounted within a sleeper cabin 14 of the vehicle 10. The sleeper unit 44 is used to provide for both the cooling and heating requirements of the ambient air within the vehicle interior 12. A user of the vehicle 10 controls the sleeper unit 44 by a programmable control module 46 (see FIG. 2) also mounted within the interior 12 of the vehicle 10. It should be noted that the power unit 8 also has a power cord 28 (see FIG. 2) that is connected to the vehicle battery 30, in order to supply start-up power to the unit 8 when activated by the control module 46.

Referring to FIG. 2, the power unit 8 includes a generator 32 that supplies electrical power at 2 voltages, 110VAC and 220VAC at 60 Hz and 5.4 kW, which are then used directly or converted to 12 VDC as required. The generator 32 can be such as but not limited to a Markon model BL105D. An air-cooled diesel engine 34 is connected to the generator 32 through a shaft 36, and uses fuel from the fuel tank 16 supplied by the fuel line 22. The engine 34 can be such as but not limited to a Kubota Model OC95-5 diesel with 9.5 Hp at 3600 RPM. The power unit 8 also has a 220 VAC-3 Hp hermetically sealed air conditioning compressor 38, which is powered by a 220 VAC power line 40 connected to the generator 32. The compressor 38 can be such as but not limited to a Danfoss model MTZ36 JG. The power unit 8 also contains an air conditioning condenser 42 that is operatively coupled to the compressor 38 through refrigerant lines (not shown).

The power unit 8 is connected to the sleeper unit 44 by the liquid refrigerant lines 24 and the electrical power line 26. The sleeper unit 44 is located within the sleeper cabin 14 to provide air temperature control of the ambient air temperature therein. The sleeper unit 32 has a cabin evaporator 48 run off of the liquid refrigerant, which is supplied by the compressor 38 and then returned thereto through the refrigerant lines 24. The evaporator 48 is used to regulate the air conditioning of the cabin 14. The sleeper unit 44 also has a 110 VAC electric heater 50 to provide for heating requirements of the cabin 14. The heater 50 is powered by the electrical line 26, which is supplied by the generator 32. A fan 48 is also included in the sleeper unit 44 to circulate the air within the cabin 14 past the evaporator 46 or the heater 50, so as to help increase the efficiency of the air temperature regulation.

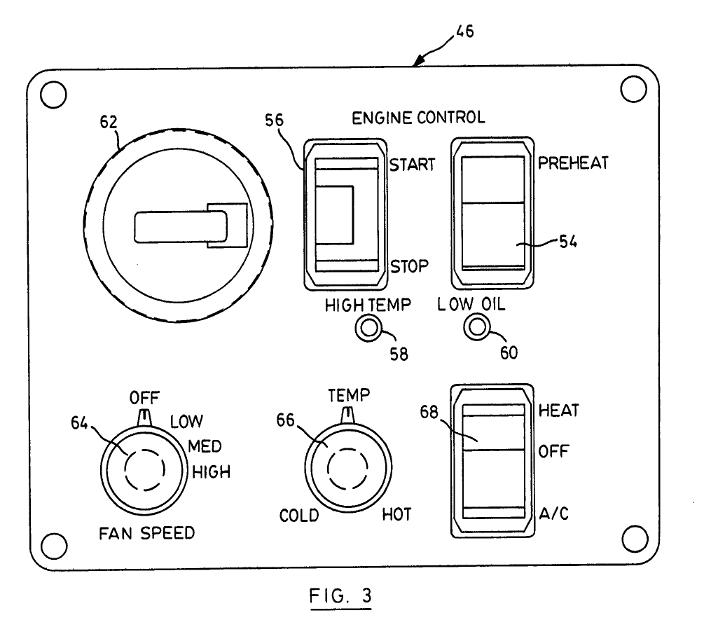

Operation of the sleeper unit 44 and the power unit 8 is controlled by the control module 46, which is accessible within the cabin interior 12 by the user of the vehicle 10. The module 46 monitors the operation of the power unit 8 through control line 47, and the sleeper unit 44 through control lines 49, 51, 53. Referring to FIG. 3, the module 46 can be such as but not limited to a solid state programmable control module. The module 46 has an engine control button 56, which can be employed by the user to manually start and stop the auxiliary engine 32 remotely from within the cabin 14. The module 46 can also have an engine pre-heat indicator 54, which indicates to the user that the engine 34 is being pre-heated before starting in cold weather conditions. The module 46 also has a fan control 64 for controlling the speed of the fan 52, such as but not limited to low, medium, and high. The module 46 also has a temperature control 66, which can be used to regulate the output of the evaporator 48 or the heater 50. A type selector 68 is provided to select between the evaporator 48 or the heater 50 for temperature regulation.

The module 46 also has indicators 58 and 60, which signal to the user that the auxiliary engine 34 is experiencing high temperatures and/or low oil pressures respectively. These indicators 58, 60 are connected by line 47 to sensors located on the engine 34, as is known in the art, which monitors for temperature and pressure alarm conditions. The module 46 also has a safety shut-down switch 62, which is triggered when the engine 34 operation encounters alarm condition(s). Accordingly, the module 46 also has a fully automatic mode that turns the power unit 8 on and off as required, which could be due to such as but not limited to low truck engine temperatures, low battery 30 voltage, and the cabin 14 temperature lower or higher than the temperature set by the temperature control 66.

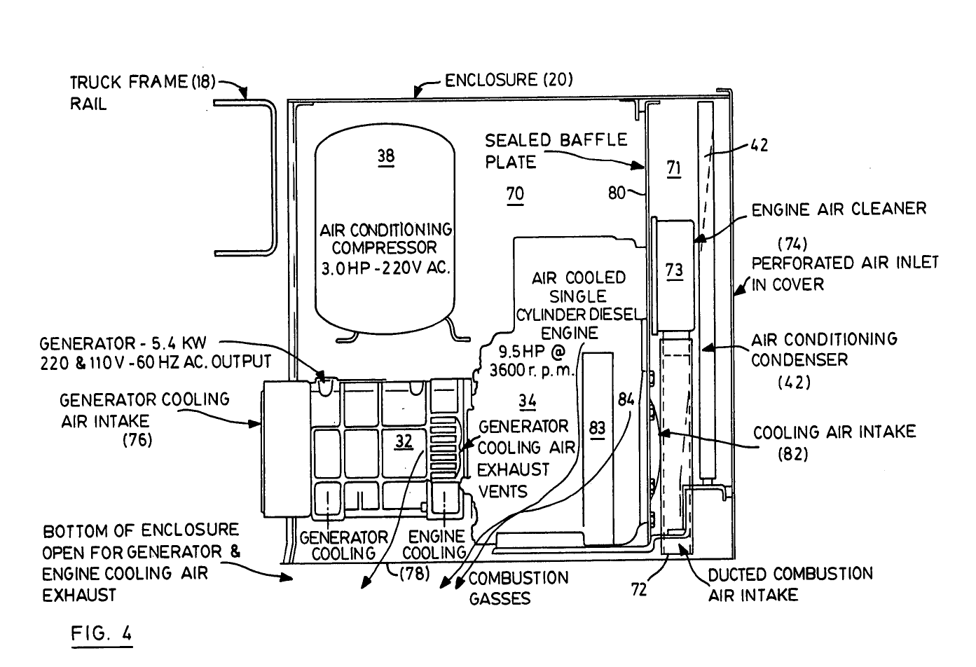

Referring to FIG. 4, the power unit 8 is contained within the housing 20, which protects the components of the power unit 8 from adverse weather conditions and guides the cooling air for the engine 34 through selected ducts to optimise cooling. The housing 20 is sealed from outside air entering the interior 70, except through an air inlet 72 for the combustion air used by the engine 34 through an air filter 73, a perforated air inlet 74 for directing cooling air over the air conditioning condenser 42 and over cooling fins 83 for cooling the engine 34, and a cooling air inlet 76 for suppying cooling air to the generator 32. The housing 20 also has a cooling air outlet 78 to direct the used cooling air from the generator 32 and the engine 34, as well as to exhaust the engine 34 combustion gases. It should also be noted that the housing 20 is divided into two regions 70 and 71 by a scaled baffle plate 80. The baffle plate 80 only allows combustion air into the engine intake 72 through the air filter 73, and the cooling air for the engine 34 through a cooling air intake 82. A cooling fan 84 draws the engine cooling air first through the perforated air inlet 74 and past the air conditioning condenser 42. This configuration provides for cooling of the condenser 42 without the need for a separate flow path and fan for the condenser 42. It should be noted that the condenser 42 was oversized for cooling of the refrigerant processed from the compressor 38, so as to help keep the air temperature rise across the condenser 42 within limits for subsequent use of the air from the inlet 74, as the air is then drawn into the inlet 82 by the fan 84 for use as engine cooling air over the fins 83.

In operation of the power unit 8, the engine 34 is first turned on by pressing the engine control button 56 into the on position. The engine 34 then begins a preheat function, as indicated by the preheat indicator 54 on the module 46, by drawing power through the line 28 from the battery 30. Once the engine 34 reaches a starting temperature, the battery 30 is used to supply the starting current required to start the engine 34. It should be noted that the battery 30 no longer supplies power once the engine 34 has started. The engine 34 then turns the generator 32 by the shaft 36, in order to generate the power required to supply the operation of the compressor 38 through line 40, the heater 50 and fall 44 through line 26, and the cooling fan 84. It should be noted that interruption of the generated power through line 40 is accomplished by the control module 46 connected to the compressor 38 by line 41.

Accordingly, the cooling fan 84 then draws cooling air through the inlet 74 and over the condenser 42 for cooling any heated refrigerant supplied by the compressor 38. This somewhat heated cooling air is then further drawn into the inlet 82 and then passed over the fins 83 to cool the engine 34. Similarly, the generator 32 directs cooling air through the inlet 76 for cooling. The used cooling air for the engine 34, generator 32, and the combustion gasses are then exhausted out of the air outlet 78. Further, the combustion inlet 72 directs combustion air through the air cleaner 73 and through the baffle plate 80 and into the engine 34.

When desired, the user then selects the air temperature on the module 46 by the temperature control 66, selects the speed of the fan 44 by the speed control selector 64, and selects either the use of the heater 50 or the evaporator 48 by the switch 68 to enable the air temperature regulation of the ambient air in the cabin 14 interior. The module 46 then regulates the operation of the selected heater 50 or evaporator 48 by turning on or off the power unit 8, as needed, so that the air temperature in the cabin 14 remains within acceptable boundaries as selected by the temperature control 66.

As described above, the power unit 8 is enclosed within the housing 20 so as to protect the unit 8 components from adverse weather, and to direct the cooling air so as to optimise cooling. However, this configuration is typically less than optimal when maintenance is required on failed or worn out components of the power unit 8. This limited ease of serviceability for the unit 8 is also farther restricted due to the positioning of the housing 20 on the rail 18.

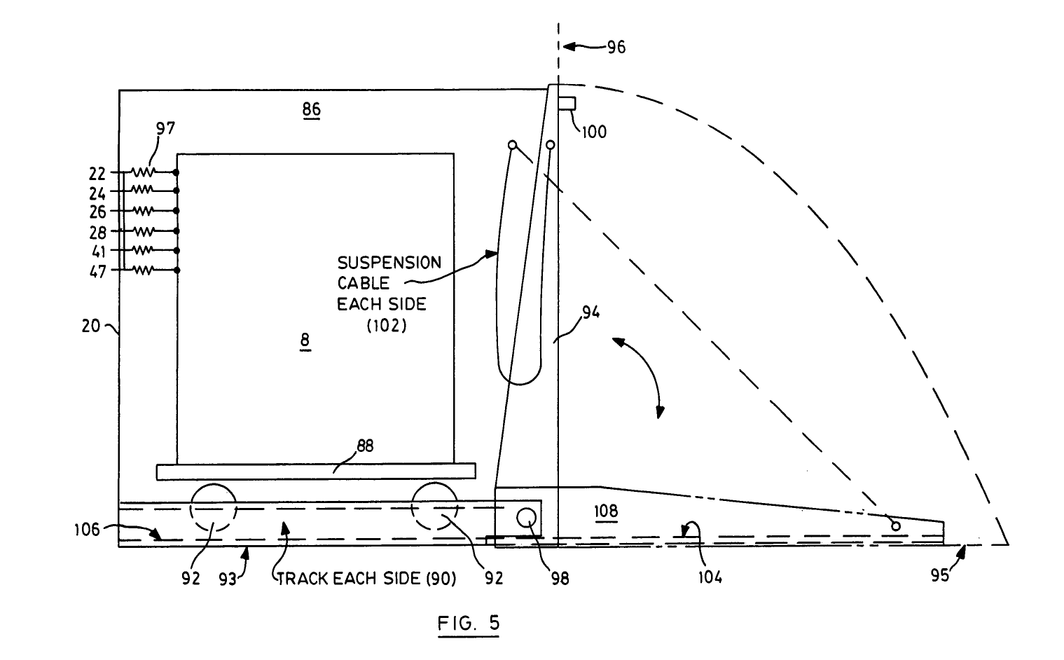

Referring to FIG. 5, a side 86 of the housing 20 has been removed for clarity. The power unit 8 is attached to a mounting frame 88, which can move along a pair of channels 90 by wheels 92. The wheels 92 are located on either side of the frame 88. The channels 90 are located on either side of the housing 20 and are fixed to the bottom 93 of the housing 20. The enclosure 20 also has a front cover 94 that opens approximately 90° between an open position indicated as arrow 95 and a closed position indicated as arrow 96. The cover 94 is hinged at a pivot point 98 at one end and can be releasably secured at the other end in the closed position 96 by a lock 100. A suspension cable 102 holds the cover 94 in the open position 95 so that the surface 104 of the cover 94 is in a plane substantially the same as an inside surface 106 of the bottom of the housing 20. Accordingly, the cover 94 has side flaps 108 that perform as extensions of the channels 90 when the cover 94 is placed in the open position 95.

Therefore, when maintenance is desired on the power unit 8, the front cover 94 is unlocked by releasing the lock 100 and the cover 94 is moved from the closed position 96 to the open position 95. The flaps 108 act as extensions of the channels 90, so that the complete power unit 8 situated on the frame 88 can be rolled on the wheels 92 out of the housing 20 and onto the surface 104 of the cover 94. Accordingly, this removal procedure brings the power unit 8 away from the vicinity of the fuel tank 16, the truck wheels17, and sleeper cabin 14 for servicing. It should be noted that the connections 22, 24, 26, 28, 41, and 47 to the power unit 8 are done by a flexible connector 97, which allows for movement of the power unit 8 without disassembly or damage to the connections 22, 24, 26, 28, 41, and 47. Once the servicing is complete, the power unit 8 can be rolled back into the housing 20, locked into position if desired by a lock (not shown), and then the cover 94 can be returned to the closed position 96 and secured by the lock 100. It is recognised that fixed mounted units 8 within the housing 20 can be used for those installations of the power unit 8 where enough space is available for servicing.

The flexible connector 97 can be such as but not limited to a GUS E-Z energy chain, which provides for bundling and containment of the connections 22, 24, 26, 28, 41 and 47 within the chain. The flexible connector 97 provides for linear strain relief, and to help support the connections 22, 24, 26, 28, 41, and 47 to permit torsional movements as well.

Further, the power unit 8 foot print can be rectangular so that the housing 20 and power unit 8 can be mounted on either of 2 sides—a long side or a short side on the rail 18. The power unit 8 mounting frame 88 in turn could be designed to mount the wheels 92 on all four sides of the frame 88, so it can be assembled to roll length-wise or cross-wise out of the housing 20. Different housings 20 are available with the either a side opening or an end opening cover 94.

Although the invention has been described with reference to certain specific embodiments, various modifications thereof will be apparent to those skilled in the art without departing from the spirit and scope of the invention as outlined in the claims appended hereto.

We claim:

1. An auxiliary power unit, for a vehicle, said unit comprising an air-cooled engine associated with an electrical generator and a compressor powered by said engine.

2. The power unit of claim 1 wherein said electrical generator provides an alternate electricity source for the vehicle.

3. The power unit of claim 1 wherein said compressor is associated with a cooling system for said vehicle.
